(19) United States
(12) Patent Application Publication
(10) Pub. No.: US 2022/0042479 A1
(43) Pub. Date: Feb. 10, 2022

(54) Hybrid Rocket Motor

(71) Applicants: Stephen A. Whitmore, Logan, UT (US); Mark C. Heiner, Logan, UT (US)

(72) Inventors: Stephen A. Whitmore, Logan, UT (US); Mark C. Heiner, Logan, UT (US)

(21) Appl. No.: 17/395,111

(22) Filed: Aug. 5, 2021

Related U.S. Application Data
(60) Provisional application No. 63/061,471, filed on Aug. 5, 2020.

(51) Int. Cl. F02K 9/72; F02K 9/28; F02K 9/42

(52) U.S. Cl. CPC F02K 9/72; F02K 9/425; F02K 9/28

(57) ABSTRACT

A rocket motor is disclosed that can include a combustion chamber containing a solid fuel that is operable to burn during operation of the rocket motor to generate combustion gas and unburned gaseous fuel. The rocket motor can also include a propellant supply containing an energy-rich oxidizer with a decomposition energy greater than or equal to 1.0 MJ/kg. In addition, the rocket motor can include a thrust augmented nozzle (TAN) operably coupled to the combustion chamber to receive the combustion gas from the combustion chamber and direct a flow of the combustion gas through the TAN. The TAN can have a divergent portion downstream of a throat, and a propellant injection port associated with the divergent portion and in communication with the propellant supply to inject the energy-rich oxidizer into the divergent portion. Only the energy-rich oxidizer, independent of another propellant, may be introduced into the flow of the combustion gas and the unburned gaseous fuel for secondary combustion of the unburned gaseous fuel and thermal decomposition of the energy-rich oxidizer within the divergent portion.

### RELATED APPLICATION

This application claims priority to U.S. Provisional Application No. 63/061,471, filed Aug. 5, 2020 which is incorporated herein by reference.

### GOVERNMENT INTEREST

None.

### BACKGROUND

Traditionally, high-expansion ratio nozzles that are very efficient in producing high levels of momentum thrust have been limited to in-space operations. Lift-off stages of conventional launch vehicles generally require either very high chamber pressure levels or low expansion ratio nozzles in order ensure that the nozzle exit pressures are sufficiently high so as to not produce suction drag or, in the extreme case, allow internal nozzle flow separation and embedded shock waves. In addition to performance loss, flow separation poses the risk of nozzle spalling or burn through. As a result, lift-off stages typically utilize low expansion ratio nozzles and are burned for only a small portion of the endo-atmospheric flight path. Additionally, multiple intermediate stages with locally optimized nozzles are used to reach orbit.

A thrust augmented nozzle (TAN) overcomes conventional limitations by injecting additional propellants downstream of the nozzle throat, resulting in secondary combustion. Downstream burning “fills-up” the nozzle and significantly raises exit pressure. This effect allows an efficient high expansion ratio nozzle to operate at low altitudes without risk of flow field separation. When the nozzle is operated in TAN mode, the thrust increase results from two effects: 1) momentum flux due to the secondary flow of gases generated by combustion of the augmentation propellants, and 2) displacement of the flow of primary combustion gases by the secondary flow. This displacement reduces the exit flow area available to the core flow, reducing overexpansion and exit plane pressure suction associated with overexpansion.

Typical thrust augmented nozzles are designed to operate with bi-propellant systems (i.e., both fuel and oxidizer) injected downstream of the nozzle throat. This requires individual flow paths for the fuel and oxidizer, which greatly increases system complexity. In addition, the fuel and oxidizer must dwell within the nozzle a sufficient time to allow for combustion in order to realize the thrust augmentation benefits of the nozzle. However, since nozzle flow Mach numbers in the divergent section downstream of the throat for thrust augmented nozzles is very high, the residence time is short and achieving good combustion can be difficult. Bi-propellant TAN systems therefore require careful tuning of the fuel and oxidizer injection ratios to be effective and typically require the use of hydrogen as the downstream injected fuel source in order to achieve good combustion properties, otherwise the combustion of hydrocarbon propellants in the nozzle is likely to be incomplete. Although a TAN system has been developed that utilized gaseous oxygen without an accompanying fuel, this required running a very rich plume (e.g., as produced by a “dirty” primary combustion with much more fuel than oxygen) in order to get useful secondary combustion. This TAN system produced cold streaks that reduced the temperature, which therefore reduced efficiency and performance.

### SUMMARY

Accordingly, a rocket motor is disclosed that achieves the desired benefits provided by thrust augmented nozzles but without the complexity of a typical bi-propellant TAN system. The rocket motor can comprise a combustion chamber containing a solid fuel that is operable to burn during operation of the rocket motor to generate combustion gas and unburned gaseous fuel. The rocket motor can also comprise a propellant supply containing an energy-rich oxidizer. In one example, a 90% aqueous solution of hydrogen peroxide, with a decomposition energy greater than or equal to 1.0 MJ/kg can be used as a propellant. As an example, the decomposition energy can range from about 1 MJ/kg at 55% decomposition efficiency to about 1.8 MJ/kg at 95% decomposition efficiency. In addition, the rocket motor can comprise a thrust augmented nozzle (TAN) operably coupled to the combustion chamber to receive the combustion gas from the combustion chamber and direct a flow of the combustion gas through the TAN. The TAN can have a divergent portion downstream of a throat, and a propellant injection port associated with the divergent portion and in communication with the propellant supply to inject the energy-rich oxidizer into the divergent portion. Only the energy-rich oxidizer, independent of another propellant, may be introduced into the flow of the combustion gas and the unburned gaseous fuel for secondary combustion of the unburned gaseous fuel and thermal decomposition of the energy-rich oxidizer within the divergent portion.

A method for augmenting thrust of a rocket motor is also disclosed. The method can comprise burning a solid fuel to generate combustion gas and unburned gaseous fuel. The method can also comprise directing flow of the combustion gas and the unburned gaseous fuel through a divergent portion of a nozzle. Additionally, the method can comprise introducing an energy-rich oxidizer with a decomposition energy greater than or equal to 1.0 MJ/kg into the divergent portion, wherein only the energy-rich oxidizer, independent of another propellant, is introduced into the flow of the combustion gas and the unburned gaseous fuel for secondary combustion of the unburned gaseous fuel and thermal decomposition of the energy-rich oxidizer within the divergent portion.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a schematic illustration of a rocket motor in accordance with an example of the present disclosure.

FIG. 2 illustrates a hollow-cone style injector having a 50° spray angle in accordance with an example of the present disclosure.

FIG. 3A-C illustrates the flow fields associated with an over-expanded, optimally-expanded, and under-expanded bell nozzle.

FIG. 4 illustrates operation of a thrust augmented nozzle (TAN) in accordance with an example of the present disclosure.

FIG. 5A is a cross-sectional side view of a thrust augmented nozzle in accordance with an example of the present disclosure illustrating a neutral propellant injection angle.

FIG. 5B is a cross-sectional side view of a thrust augmented nozzle in accordance with an example of the present disclosure illustrating a forward-facing propellant injection angle.

FIG. 5C is a cross-sectional side view of a thrust augmented nozzle in accordance with an example of the present disclosure illustrating a rearward-facing propellant injection angle.

FIG. 6 is a graph of thrust over time for one example test.

FIG. 7 is a graph of mass flow rate over time for the example of FIG. 6.

FIG. 8 is a graph of thrust coefficient versus augmentation ratio in accordance with several examples.

FIG. 9 is a graph of exit pressure and secondary injection mass flow rate as a function of time for Test #10.

FIG. 10 is a graph of thrust coefficient as a function of secondary injection initial droplet diameter and flow rate in accordance with several examples.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a fuel grain” includes reference to one or more of such fuel grains and reference to “the injection port” refers to one or more of such injection ports.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, or combinations of each.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

Hybrid Rocket Motor

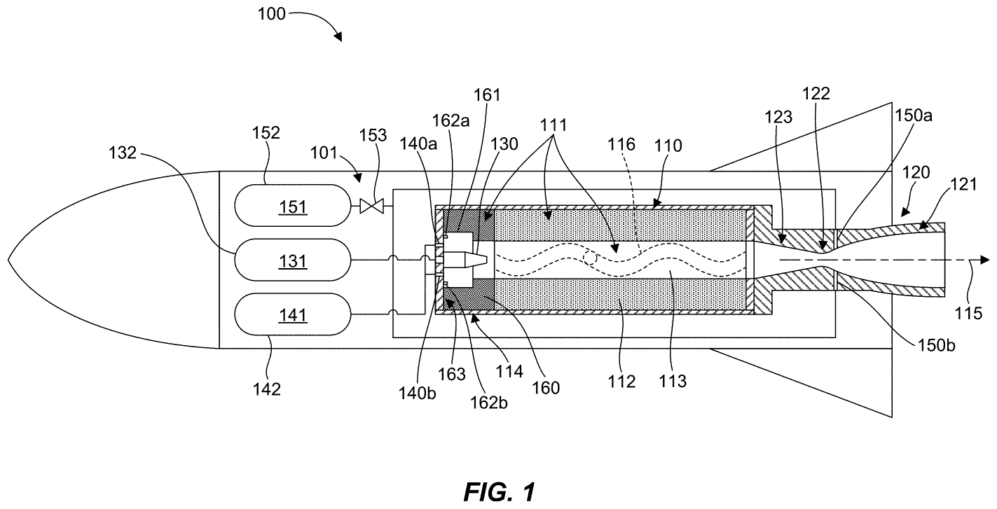

With reference to FIG. 1, a rocket system 100 in accordance with an example of the present disclosure is schematically illustrated. The rocket system 100 can include a rocket motor 101. In general, the rocket motor 101 can include a combustion chamber 110 and a nozzle 120. The combustion chamber 110 can contain a solid fuel 111 that is operable to burn during operation of the rocket motor 101. The rocket motor 101 can also include an oxidizer injection port 130 associated with the combustion chamber 110 and operable to inject an oxidizer 131 (e.g., from an oxidizer supply or tank 132) into the combustion chamber 110 to facilitate combustion of the solid fuel 111. Thus, the rocket motor 101 can be a hybrid solid-liquid rocket motor.

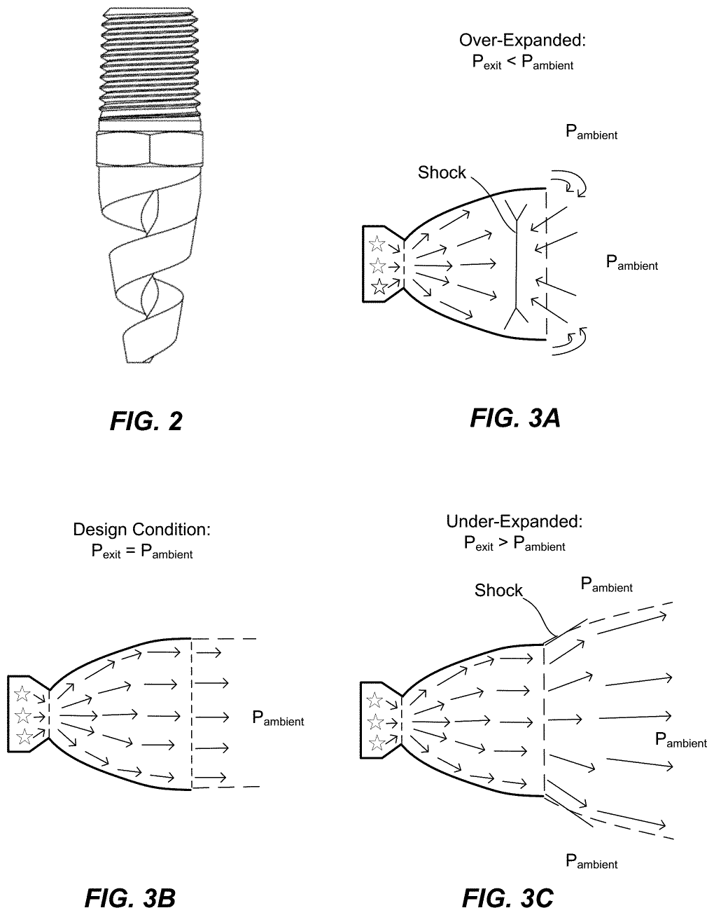

The combustion chamber 110 can be of any suitable construction or configuration known in the art (e.g., a hollow cylindrical shell) and can be made of any suitable material known in the art (e.g., carbon composite). The oxidizer 131 can be any suitable type or composition of oxidizer, such as but not limited to at least one of hydrogen peroxide (e.g., concentrations greater than or equal to 85%), gaseous oxygen, liquid oxygen, nitrous oxide, hydroxylammonium nitrate, ammonium dinitramide, air, or a blend of multiple oxidizers which may be selected based at least in part on desired performance with a given solid fuel 111. The oxidizer 131 can be injected into the combustion chamber 110 through an injector 130 of any suitable type or configuration. In one aspect, the injector 130 is a hollow-cone style injector, which may provide shorter latencies and higher combustion efficiency compared to other injector types. An example of a suitable hollow-cone style injector is shown in FIG. 2. In this example, the hollow-cone injector has a spiral configuration, although other configurations are contemplated, including but not limited to, a single-port axial injector or a fan-spray injector.

Referring again to FIG. 1, the solid fuel 111 can be of any suitable type or composition such as, but not limited to, acrylic or hydroxyl-terminated polybutadiene (HTPB), ammonium dinitramide, ammonium nitrate-based (ANCP), ammonium perchlorate-based (APCP), Acrylonitrile Butadiene styrene (ABS), or any other suitable solid grain propellant known in the art, alone or in any combination. In some examples, the solid fuel 111 can comprise a thermoplastic material, such as at least one of acrylonitrile butadiene styrene (ABS), low density polyethylene (LDPE), or high-impact polystyrene (HIPS), although composite solid fuels may also be used. The solid fuel 111 can also be of any suitable configuration, such as at least one of a cylindrical fuel grain 112, a helical bore fuel grain 113, or a non-catalytic arc-ignition system 114. Examples of helical bore fuel grains are found in United States Patent Application Pub. No. 2016/0194256 “Solid Grain Structures, Systems, and Methods of Forming the Same,” which is incorporated herein by reference in its entirety. Examples of a non-catalytic arc-ignition systems are found in United States Patent Application Pub. No. 2020/0025151 “Methods and Systems for Restartable, Hybrid-Rockets” and U.S. Pat. No. 10,527,004 “Restartable Ignition Devices, Systems, and Methods Thereof,” each of which is incorporated herein by reference in its entirety. Aspects of the helical bore fuel grain 113 and the arc-ignition system 114 as related to the present technology are discussed in more detail below.

The arc-ignition system 114 can include a housing 160 formed of multiple flat layers by employing fused deposition modeling (FDM), three-dimensional printing, or other suitable techniques. Such FDM process provides an internal surface 161 with ridges formed from the multiple flat layers deposited one upon another. The arc-ignition system 114 can also include electrodes 162a, 162b spaced from each other and positioned adjacent the internal surface 161. The electrodes 162a, 162b can be operable to generate an electrical potential field between the electrodes 162a, 162b.

The arc-ignition system 114 can additionally include one or more oxidizer injection ports 140a, 140b associated with the combustion chamber 110. The oxidizer injection ports 140a, 140b can be operable to inject an oxidizer 141 (e.g., from an oxidizer supply or tank 142) into the combustion chamber 110 to initiate combustion between the oxidizer 141 and the solid fuel 111 prior to injection of the oxidizer 131 to facilitate thermal decomposition of the oxidizer 131. The second oxidizer 141 can be any suitable type or composition of oxidizer, such as gaseous oxygen, which may be selected based at least in part on desired performance with a given solid fuel 111. In one example, the oxidizer 141 can be injected through one or more outer concentric injection ports 140a, 140b, and the oxidizer 131 can be injected through a middle injector 130. The injector 130, the injection ports 140a, 140b, and/or the electrodes 162a, 162b can be supported by or integrated into an injector cap 163, which can also serve to provide a pressure boundary for the combustion chamber 110. Upon the propellant or oxidizer 141 being injected into the system via oxidizer injection ports 140a, 140b and activating an electrical potential field between the electrodes 162a, 162b, the ridges along the internal surface 161 may concentrate an electrical charge that seeds combustion of the solid grain fuel material. The unique structural characteristics of the material and structure of the internal surface 161 and housing 160 provide an ignition system 114 that is restartable.

The arc-ignition technology derives from the electrical breakdown properties of certain 3-D printed thermoplastics like ABS, LDPE, and HIPS. For example, in FDM processing, a plastic filament is unwound from a coil that supplies material to an extrusion nozzle. The nozzle is heated to melt the feed-stock, and its position is computer numerically controlled (CNC) in three dimensions using a robotic mechanism. Because FDM manufacturing builds the specimen one layer at a time, each printed layer is microscopically thin at the surface. When exposed to an electrostatic potential field, the layered structure concentrates minute positive and negative electrical charges. The charge asymmetry produces localized arcing between material layers, and the dissipated energy results in a material glass-transition from crystalline to amorphous. The amorphous layer is highly conductive, allowing the electrical arcs to cause a surface char-layer with the result being a surface “arc-track.” Joule heating along this surface arc-track allows sufficient fuel material pyrolysis so that combustion occurs spontaneously once a local oxygen partial pressure of approximately two atmospheres is reached. The high oxygen concentration is provided by an external oxidizer flow. Thus, the non-catalytic arc-ignition system 114 can be configured to thermally decompose the core oxidizer 131 flow. The arc-ignition concept can provide a power-efficient system that can be started, stopped, and restarted with a high degree of reliability.

In this non-catalytic ignition approach, the oxidizer 131 (e.g., hydrogen peroxide) flow is preceded by a small flow of the oxidizer 141 (e.g., gaseous oxygen) injected into the combustion chamber 110 lined with the 3-D printed thermoplastic fuel (e.g., ABS). The arc-ignition system 114 weakly initiates combustion between the injected oxidizer 141 (e.g., gaseous oxygen) and the 3-D printed thermoplastic fuel, and is followed by the oxidizer 131 (e.g., hydrogen peroxide) flow. With a properly tuned oxidizer 141 (e.g., gaseous oxygen) pre-lead massflow, there exists sufficient energy to decompose the incoming oxidizer 131 (e.g., hydrogen peroxide) flow, while simultaneously initiating full-length hybrid combustion. Once decomposition of the oxidizer 131 (e.g., hydrogen peroxide) begins, then the additional energy of decomposition contributes to the overall combustion process. After the oxidizer 141 (e.g., gaseous oxygen) pre-lead is terminated, combustion is sustained by the oxygen liberated by the thermal decomposition of the oxidizer 131.

The fuel grain 113 defines a bore or helical fuel port 116 extending in a longitudinally inside the fuel grain 113. The bore 113 extends with a helical configuration along the length of the fuel grain 113, although a straight or other shaped bore may be used. The embedded helical port or bore 116 provides an extended length flow path and a large surface area contact in a short form factor. Centrifugal forces created by combustion gases and oxidizer rotating in and flowing through the helical fuel port or bore 116 significantly increases the fuel regression rates and propellant mass flow from the fuel grain. In order to significantly increase the regression rate, a helical port or bore 116 fuel design feature increases the nominal surface skin friction while also minimizing the effects of radial surface blowing. A helical pipe flow with cylindrical ports shows significantly increased end-to-end pressure losses when compared to flows through straight pipes with identical cross sections. Thus, helical flows have the effect of significantly increasing the local skin friction coefficient. Helical flows also introduce a centrifugal component into the flow field. In hybrid rocket applications, this centrifugal component will have the effect of thinning the wall boundary layer, bringing the flame zone closer to the wall surface and increasing the flame diffusion efficiency. An increased flame diffusion efficiency increases O/F ratios. Helical fuel ports in a wide variety of cross-sectional areas can be easily manufactured using acrylonitrile butadiene styrene (ABS) fuel materials manufactured by FDM techniques.

ABS is a thermoplastic that melts before vaporizing when subjected to heat. This property makes ABS one of the materials of choice for fused deposition modeling (FDM) rapid prototyping machines. Because ABS can be formed into a wide variety of shapes using modern additive manufacturing and rapid prototyping techniques, it is possible to embed complex high-surface area flow paths within the fuel grain. Non-limiting options can include a cylindrical helix, embedded chambers that open up during burning, or multiple port configurations. These internal flow paths allow for motor aspect ratios that are significantly shorter than can be achieved using conventional solid, hybrid, or mono-propellant technologies.

The solid fuel 111 can be made or manufactured utilizing any suitable process or technique, such as extruding (e.g., to manufacture the cylindrical fuel grain 112), three-dimensional (3-D) additive manufacturing (e.g., fused deposition modeling (FDM) or 3-D printing to manufacture the helical bore fuel grain 113 and/or the arc-ignition system 114), casting, molding, etc. In one aspect, the helical bore fuel grain 113 can be configured as an insert that fits within the cylindrical fuel grain 112. In another aspect, the arc-ignition system 114 can be configured as a cap that fits on the helical bore fuel grain 113 and/or the cylindrical fuel grain 112 Thus, in one example, the solid fuel 111 can be configured as a three-piece fuel grain that includes an extruded cylindrical fuel grain 112, a 3-D printed helical bore fuel grain 113 insert, and a 3-D printed arc-ignition system 114 cap. This manner of construction may significantly reduce manufacturing cost compared to other typical manufacturing alternatives. During the most common type of 3-D printing for thermoplastics, Fused-Deposition Molding (FDM), the printer lays down the fuel material onto a polylactic acid (PLA) support structure. This structure can be dissolved by solvents after the piece is completed.

The nozzle 120 can be of any suitable construction or configuration known in the art (e.g., a convergent-divergent nozzle) and can be made of any suitable material known in the art (e.g., iron-based alloys, nickel-based alloys, titanium-based alloys, carbon composite, etc.). The nozzle 120 can be operably coupled to the combustion chamber 110 to receive the combustion gas from the combustion chamber 110 and direct a flow 115 of the combustion gas through the nozzle 120. The nozzle 120 can have a divergent portion 121 downstream of a throat 122. In some examples, the nozzle 120 can have a convergent portion 123 upstream of the throat 122 that receives gas (e.g., combustion gas) from the combustion chamber 110. Generally, for launch systems a high-expansion ratio nozzle is used in order to give best performance at high altitudes.

In one aspect, the rocket motor 101 can be tuned or configured such that burning of the solid fuel 111 during operation of the rocket motor 101 generates combustion gas and unburned gaseous fuel. This unburned gaseous fuel can be utilized for secondary combustion with a secondary oxidizer in the nozzle 120, as described in more detail below. In one aspect, the nozzle 120 can be a thrust augmented nozzle (TAN) configured to generate additional thrust from secondary combustion of the unburned gaseous fuel. The nozzle 120 can also have a propellant injection port 150a, 150b associated with the divergent portion 121. Although two propellant injection ports are illustrated in FIG. 1, it should be recognized that any suitable number of propellant injection ports can be utilized in accordance with the principles disclosed herein. One particularly useful arrangement of the injection ports are a ring-pattern with injection perpendicular to the flow stream. The orthogonal injection sites allow maximum penetration into the core flow, and the stream impingements help to break up an atomize the injected fluid.

In addition, the rocket motor 101 can include a propellant supply or tank 152, which can contain an energy-rich oxidizer 151. The propellant injection port 150a, 150b can be in communication with the propellant supply 152 to selectively inject the energy-rich oxidizer 151 into the divergent portion 121. A control valve 153 can be included to control flow of the energy-rich oxidizer 151 to the propellant injection port 150a, 150b. Operation of the control valve 153 can be controlled in any suitable manner in accordance with the principles disclosed herein, such as by a control system (not shown) of the rocket system 100, as known in the art. The energy-rich oxidizer 151 can be introduced into the flow 115 of the combustion gas and the unburned gaseous fuel for secondary combustion of the unburned gaseous fuel and thermal decomposition of the energy-rich oxidizer 151 within the divergent portion 121. Thermal decomposition of the energy-rich oxidizer 151 can release energy in the form of heat, which can be harvested by the rocket motor 101 to provide additional benefits, as described in more detail below. In one aspect, only the energy-rich oxidizer 151, independent of another propellant, is introduced into the flow 115 of the combustion gas and the unburned gaseous fuel for secondary combustion and thermal decomposition within the divergent portion 121. In other words, only a single propellant is injected into the nozzle 120 for secondary combustion of the fuel-rich flow of gas through the nozzle 120, at the exclusion of any other propellant added via the nozzle 120 to the flow of gas for secondary combustion. Added constituents to the injected stream that do not possess a high energy of decomposition are likely to reduce the overall system performance and reliability. As opposed to designs that inject multiple propellants (e.g., oxidizer and fuel) into a nozzle for secondary combustion, requiring or utilizing only a single energy-rich propellant (e.g., oxidizer) for secondary combustion can provide simplicity in the design of the secondary injection path hardware, reduced weight, reduced space occupied by the secondary injection hardware, and reduced cost, among other benefits.

The rocket motor 101 can be configured to burn the solid fuel 111 and the oxidizer 131 fuel-rich, and then the secondary energy-rich oxidizer 151 can be injected downstream into the hot flow field through the nozzle 120. When the secondary energy-rich oxidizer 151 is injected into the nozzle 120 downstream of the throat 122, the hot unburned, pyrolyzed hydrocarbons in the plume spontaneously ignite. In some examples, the energy-rich oxidizer 151 can be the same type of oxidizer as the oxidizer 131 provided to the combustion chamber 110 for primary combustion. In this case, these oxidizers can be provided by the same or different supplies or tanks to the combustion chamber 110 and the nozzle 120, as appropriate. Although nitrous oxide does not have as large of a decomposition energy as peroxide; because it has two phase properties and a high vapor pressure, it will decompose more readily in the plume, and may increase the efficiency for smaller nozzle configurations.

As discussed above, in order to achieve secondary combustion, a high proportion of unburned fuel in the combustion chamber outlet products is required. In one aspect, the helical bore fuel grain 113 can provide an efficient way to significantly lower the oxygen to fuel (O/F) ratio of the combustion chamber exhaust products. The helical bore fuel grain 113 can increase the fuel regression rate and lower the initial O/F ratio. Although exact parameters can vary per design criteria, as a general guideline, fuel regression rates can range from about 0.5 mm/s for small thrusters to greater than 4 mm/sec for large motors. The initial optimal O/F ratio depends up on the choice of propellants. For burning of hydrocarbons in a 90% aqueous peroxide solution the stoichiometric O/F ratio can vary from approximately 6.5 to 7.5, with an O/F ratio varying from approximately 4.5 to 5.5 providing particularly good results. With that said, operating at an O/F ratio slightly below optimal, allows for residual fuel in the plume that can react with the secondary oxidizer injection. This can leave more chemical potential energy in the core flow to react with the secondarily injected oxidizer 151. In addition, the gas flow through the nozzle 120 already has a fuel component that has been pyrolyzed upstream so there is no latency of combustion. Once the decomposed oxidizer 151 reacts with the fuel-rich core flow, the released heat can enable the remaining oxidizer 151 to react more freely. The helical bore fuel grain 113 can also spin the exhaust products, allowing for better mixing and slightly longer dwell time in the nozzle 120. Thus, the helical port in the fuel grain can significantly increase fuel regression rate, which can result in a fuel-rich plume exiting the nozzle throat 122 and aid in secondary combustion of the fuel with the energy-rich oxidizer 151.

In one aspect, the energy-rich oxidizer 151 can be any suitable oxidizer with a decomposition energy greater than or equal to 1.0 MJ/kg. For example, the energy-rich oxidizer 151 can comprise at least one of hydrogen peroxide, nitrous oxide, or mixture of nitrides (MON). In a specific example, the energy-rich oxidizer 151 can comprise a hydrogen peroxide solution having a concentration greater than or equal to 85%. In one example, the hydrogen peroxide solution has a concentration of 90%.

Hydrogen peroxide is a relatively dense and reactive propellant which provides a powerful decomposition reaction that releases a large amount of decomposition energy (e.g., in the form of heat) when it thermally decomposes and separates to form hydrogen and oxygen. Thermal decomposition of hydrogen peroxide is much more rapid than the combustion chemical reaction. Therefore, when hydrogen peroxide is injected into the nozzle 120 downstream of the throat 122, hot unburned hydrocarbons from the fuel can burn (e.g., spontaneously ignite) with the oxygen released by the thermal decomposition of the hydrogen peroxide, releasing heat from both secondary combustion and thermal decomposition of the hydrogen peroxide. Thus, heat can be derived from both thermal decomposition and secondary combustion of released oxygen with residual fuel in the core flow, which can prevent cold streaks from developing in the nozzle 120. The secondary hydrogen peroxide decomposition can also produce large volumes of gas that are captured by the nozzle 120, which can significantly increase the exit pressure and eliminate the associated pressure drag coming out of the nozzle 120 to improve performance over a typical oxidizer (e.g., gaseous oxygen) that does not provide a substantial, or any, decomposition energy.

In one aspect, both the fuel composition of the plume and the secondary injection of the energy-rich oxidizer 151 can be tuned to achieve suitable hybrid thrust augmentation. For example, the stoichiometric O/F ratio for 90% hydrogen peroxide and ABS combustion is 5.5. Thus, hydrogen peroxide can provide a desired thrust augmentation effect with a relatively lean (i.e., less rich) fuel plume compared to what may be required to achieve a similar effect using a typical oxidizer, such as gaseous oxygen. One advantage of running slightly fuel rich is that this provides cooler temperatures inside the nozzle throat 122, which can minimize or eliminate nozzle erosion. Although running fuel rich, overall performance may not suffer because performance (e.g., thrust) is recovered downstream of the nozzle throat 122 at the back end of the nozzle 120 (e.g., the divergent portion 121) where additional energy can be extracted. In addition, the high heat generated by the thermal decomposition and secondary combustion provides benefits such as increased pressure at the back end of the nozzle 120. Secondary injection and combustion can therefore enable a high or large expansion ratio nozzle, greater than or equal to 50:1, with a suitable chamber pressure level. At low altitudes such a large expansion ratio normally can be un-started with embedded shock waves. A high expansion ratio nozzle, which provides more momentum thrust than smaller expansion ratio nozzles, is typically only practical at higher altitudes. Thus, with the present technology, a high expansion ratio nozzle can be utilized at both high and low altitudes.

Conventional fixed-geometry rocket nozzles allow optimum performance only at one specific ambient pressure or operating altitude. Thus, conventional nozzles necessarily represent a design compromise. In a conventional nozzle, combustion gases are choked by a cylindrical throat and then expand through a diverging nozzle pathway, exchanging thermal energy for kinetic energy, and creating a large increase in momentum of the exit plume. The optimal operating condition for a conventional nozzle occurs when the pressure at the exit plane exactly equals the background ambient pressure, and this condition is set by the chamber pressure and expansion ratio. FIG. 3A-C shows the flow fields associated with an over-expanded, optimally-expanded, and under-expanded bell nozzle. For the conventional nozzle, careful design is needed to achieve desired high altitude (under-expanded operating conditions) performance while avoiding flow separation and an embedded shock wave when operating at low altitudes (over-expanded operating conditions).

The over-expanded nozzle develops an exit pressure that is less than the surrounding atmospheric pressure, and a locally negative pressure gradient results. When the negative pressure gradient becomes sufficiently strong, boundary layer separation and backflow can form along the nozzle walls. Backflow and flow separation typically result in the formation of an embedded shockwave. The embedded shock wave leads to a loss of performance, and possible structural failure due to high heating levels at the shock-wall interface and dynamic loads due to flow separation.

For under-expanded conditions the nozzle is fully started and isentropic. However, the exit plane pressure is substantially higher than ambient, meaning that the only a portion of the thermal energy of the plume has been recovered and converted into kinetic energy. The result is the potential for a considerable loss in the available nozzle momentum thrust. Consequently, typically lower expansion ratio nozzles are used for low altitude operation, and high expansion ratio nozzles are reserved for near-space operations.

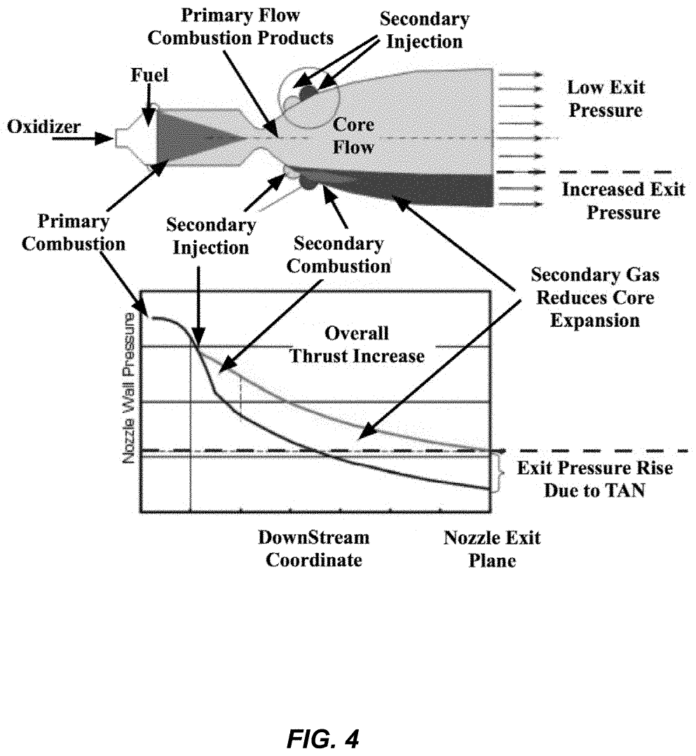

The technology disclosed herein can provide a practical solution for altitude compensation by operating an over expanded nozzle at low altitudes, and then “filling up” the nozzle to match ambient exit pressure, injecting and burning propellant downstream of the throat in the divergent section of the nozzle, as illustrated in FIG. 4. By injecting propellant into the divergent section of the over expanded nozzle, the exit pressure is increased and is driven towards the optimal level. The secondary mass flow can be varied based on ambient conditions. The effects of secondary injection may become more pronounced with higher expansion ratios. At higher expansion ratios (e.g., larger than 25:1), sea-level specific impulse (Iₛₚ) may increase with added secondary mass flow (i.e., at a sufficiently high expansion ratio the specific impulse will be increased with added propellant). When looking at mission averaged specific impulse, significant increases in thrust may be obtained using secondary injection with only minimal losses in mission averaged specific impulse. Thus, TAN may be effectively used as a lightweight secondary booster. By applying TAN at the beginning of the launch phase, the thrust can be dramatically increased where added thrust is most needed, and then can be turned off once the atmosphere is thinner and after the trajectory has “bent-over” where gravity losses are not as significant. Such an approach has the potential to increase the operating Iₛₚ of the system by as much as 15%. Thus, for a system normally achieving an effective Iₛₚ of 300 seconds, the achieved Iₛₚ of the TAN system could be as high as 345 seconds.

With further reference to FIG. 1, the propellant injection port 150a, 150b can include any suitable type of fluid port having any suitable configuration. In some examples, the propellant injection port 150a, 150b can comprise at least one of an atomizer nozzle (e.g., utilizing the venturi effect) and/or a conical spray head (e.g., a spiral cone nozzle, a hollow cone-shaped nozzle, or a solid cone-shape nozzle), as commonly known in the art. Such nozzles can be utilized to break the energy-rich oxidizer 151 up into droplets or particles to speed decomposition and provide a complete burn with the gaseous fuel flow in the nozzle 120. In general, the droplet size of the injected energy-rich oxidizer 151 should be minimized to enable sufficient vaporization of the droplets for efficient TAN operation. In one aspect, the injected energy-rich oxidizer 151 can have a droplet size less than or equal to 50 microns, which can be achieved by selecting an appropriate propellant injection port 150a, 150b.

The propellant injection port 150a, 150b can be operably coupled to the propellant supply 152 in any suitable manner known in the art. Similarly, the oxidizer injection ports 130, 140a-b can be operably coupled to the respective oxidizer supplies or tanks 132, 142 in any suitable manner known in the art. Pipes, valves, gas pressurization devices, control electronics, etc. have been omitted from the FIG. 1 illustration, but may be included as desired to controllably inject propellant into the nozzle 120 and oxidizers into the combustion chamber 110.

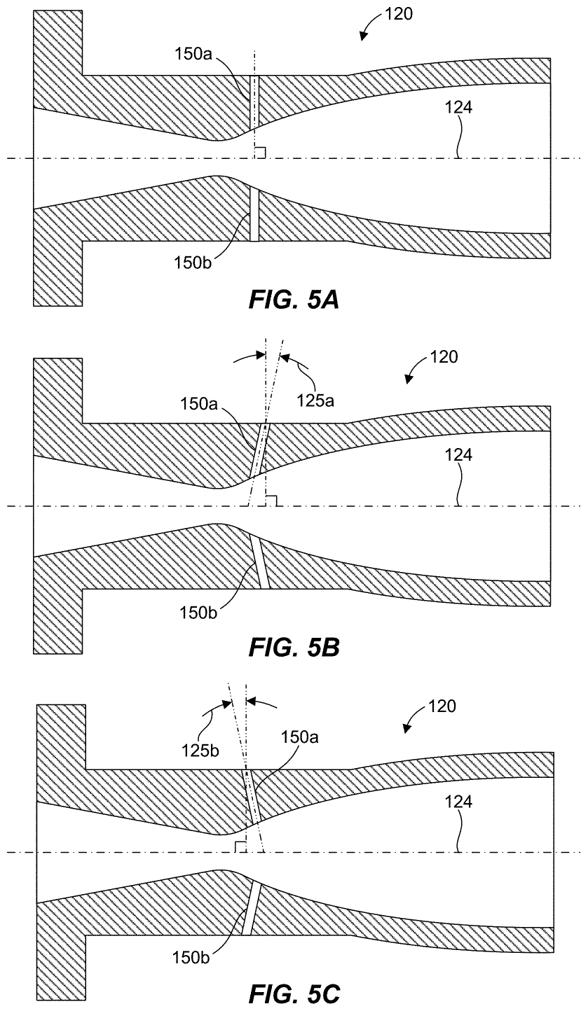

The propellant injection port 150a, 150b can be located in the divergent portion 121 just aft of the nozzle throat 122. The propellant injection port 150a, 150b can be oriented at any suitable angle relative to the flow 115 of gas through the nozzle 120 (e.g., parallel to a longitudinal axis 124 of the nozzle 120 as shown in FIGS. 5A-5C) to achieve adequate mixing and dwell time of the injected energy-rich oxidizer 151 in the divergent portion 121. In one aspect, shown in FIG. 5A, the propellant injection port 150a, 150b can be oriented at a neutral angle relative to the flow 115 of gas through the nozzle 120 (e.g., parallel to a reference perpendicular to the longitudinal axis 124). In another aspect, shown in FIG. 5B, the propellant injection port 150a, 150b can be oriented at a forward-facing injection angle 125a relative to the flow 115 of gas through the nozzle 120 (e.g., a forward-facing angle 125a from a reference perpendicular to the longitudinal axis 124). In some examples, the propellant injection port 150a, 150b can be oriented at a forward-facing injection angle 125a up to and including 10 degrees. In a particular example, the propellant injection port 150a, 150b can be oriented at a forward-facing injection angle 125a of 10 degrees. In yet another aspect, shown in FIG. 5C, the propellant injection port 150a, 150b can be oriented at a rearward-facing injection angle 125b relative to the flow 115 of gas through the nozzle 120 (e.g., a rearward-facing angle 125b from a reference perpendicular to the longitudinal axis 124). It should be recognized that the propellant injection ports 150a, 150b can be oriented at the same injection angle or different injection angles, as desired.

Furthermore, it is recognized that the axial location, diameter, and angle of the injection nozzle can effect performance. As a general guideline, the axial location can be within about 10% (and some cases within about 5%) of a point (or shorter) at which the wall pressure is equal to ambient pressure for a lowest predicted chamber pressure. Such a position can help to reduce chances of flow separation. Similarly, a nozzle diameter can be chosen so as to improve penetration and mixing.

In one aspect, a catalyst (e.g., silver) can be introduced to the energy-rich oxidizer 151 upstream of the propellant injection port 150a, 150b to begin the decomposition process of the energy-rich oxidizer 151 (e.g., partial catalytic decomposition) prior to introduction into the nozzle 120, as opposed to relying only on thermal decomposition of the energy-rich oxidizer 151 in the nozzle 120, which can reduce latencies. In another aspect, the length of the nozzle 120 (e.g., the divergent portion 121) can be increased to increase the dwell time of the energy-rich oxidizer 151 in the nozzle to enable complete decomposition, which can increase the amount of energy that can be recovered from the energy-rich oxidizer 151.

In accordance with one embodiment of the present invention, a method for augmenting thrust of a rocket motor is disclosed. The method can comprise burning a solid fuel to generate combustion gas and unburned gaseous fuel. The method can also comprise directing flow of the combustion gas and the unburned gaseous fuel through a divergent portion of a nozzle. Additionally, the method can comprise introducing an energy-rich oxidizer with a decomposition energy greater than or equal to 0.5 MJ/kg into the divergent portion, wherein only the energy-rich oxidizer, independent of another propellant, is introduced into the flow of the combustion gas and the unburned gaseous fuel for secondary combustion of the unburned gaseous fuel and thermal decomposition of the energy-rich oxidizer within the divergent portion. It is noted that no specific order is required in this method, though generally in one embodiment, these method steps can be carried out sequentially.

In one aspect, the energy-rich oxidizer comprises at least one of hydrogen peroxide or nitrous oxide. In another aspect, introducing the energy-rich oxidizer comprises forming the energy-rich oxidizer into droplets sized less than or equal to 50 microns. In yet another aspect, introducing the energy-rich oxidizer comprises directing the energy-rich oxidizer at a forward-facing injection angle. In one aspect, the method can further comprise introducing a fluid oxidizer to the solid fuel while burning the solid fuel.

### Example 1

A rocket motor system generally aligned with FIG. 1 was tested. Baseline tests were performed with a conical nozzle having an expansion ratio of 2.594:1. A secondary TAN nozzle port was formed having a modular injection port design to allow for testing of different nozzle contours, angles, and positions. A maximum angle of 26.126° was used for the TAN injection nozzle with a 10° forward-facing injector angle, an expansion ratio of 16:1, a 0.37 inch downstream axial location, and an injection diameter of 0.026 inches. The injector nozzles were also located at an axial location corresponding to a theoretical calculation of where the wall pressure equaled ambient pressure for 150 psi as a lowest predicted chamber pressure.

An arc-ignition system was used as previously described having electrode ends ¼ inch apart. Combustion was initiated using GOX/ABS as oxidizer/fuel and 90% hydrogen peroxide was used as the secondary TAN injection propellant. The arc-ignitor was activated for only about two seconds, one second before peroxide injection, after which the reaction is self-sustaining.

An extruded ABS fuel grain and 3D printed helical fuel grain insert were used as the solid fuel. A hollow cone injector (as in FIG. 2) was used for hydrogen peroxide injection with coaxial GOX ports about the hollow cone injector. Firing and injector sequences involved an initial spark generation, followed by GOX injection (from the coaxial injectors about the hollow cone injector), followed by primary hydrogen peroxide injection, and then secondary TAN hydrogen peroxide injection. GOX is typically terminated at about 2-3 seconds, while main and secondary hydrogen peroxide is sustained for the duration of a burn.

Fourteen tests were performed, including three non-TAN baseline tests, as outlined in Table 1.

TABLE 1
Test Matrix Summary.

| | | | Burn | SI | Approx. SI | Fuel Mass |
|---|---|---|---|---|---|---|
| | | Fuel | Duration | Duration | Flow Rate | Consumed |
| Test # | Test Type | Grain | (sec) | (sec) | (g/sec) | (g) |
| 1 | Baseline | Helical | 9 | — | — | 241 |
| 2 | Baseline | Helical | 10 | — | — | 231 |
| 3 | Baseline | Helical | 10 | — | — | 259 |
| 4 | TAN | Straight | 7 | 4 | 16 | 71 |
| 5 | TAN | Straight | 8 | 4 | 6.5 | 96 |
| 6 | TAN | Helical | 12 | 8 | 12 | 269 |
| 7 | TAN | Helical | 13 | 8 | 11.5 | 280 |
| 8 | TAN | Helical | 10 | 6 | 10 | 268 |
| 9 | TAN | Helical | 10 | 6 | 19 | 251 |
| 10 | TAN | Helical | 10 | 6 | 24 | 247 |
| 11 | TAN | Helical | 10 | 6 | 15 | 265 |
| 12 | TAN | Helical | 10 | 6 | 5.5 | 259 |
| 13 | TAN | Helical | 10 | 6 | 11 | 256 |

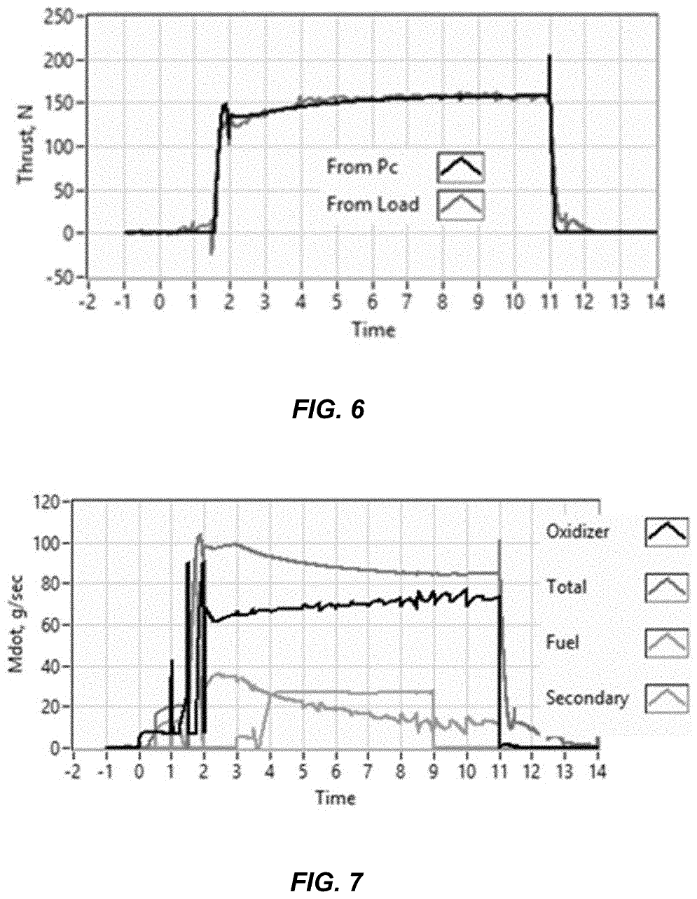

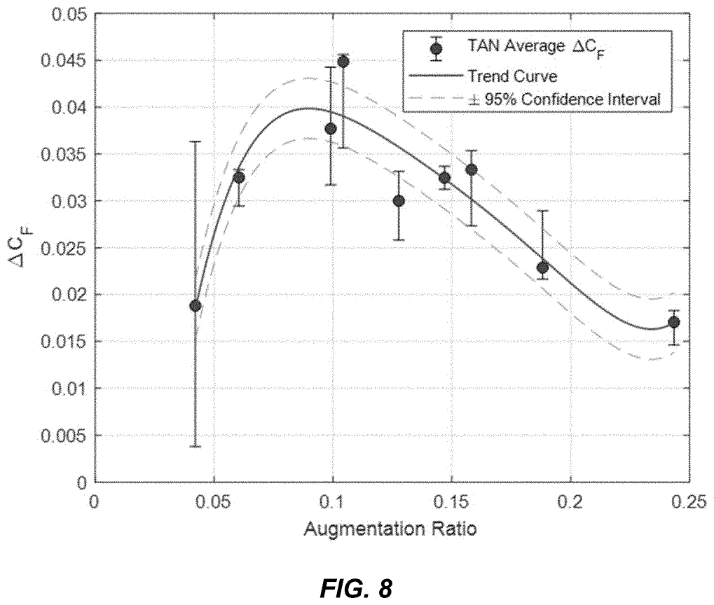

Tests 1 and 2 were performed using a cylindrical primary port and no increase in thrust was observed. Tests 3-13 were performed using the helical cone port. FIG. 6 is a typical thrust profile from these tests which exhibit a bump in thrust at about 4 seconds when secondary propellant as added as shown in FIG. 7 which shows mass flow rate of each component over time.

As a point of comparison, the change in thrust coefficient, ΔC_{F}, and augmentation ratio, AR, were calculated for each burn and plotted in FIG. 8. Augmentation ratio is defined as a dimensionless secondary injection mass flow rate (i.e. mass flow rate of secondary divided by primary mass flow rate). There appears to be a maximum at an augmentation ratio of about 0.9. Generally, it appears that an augmentation ratio of 0.06 to about 1.1 can be useful. The thrust should increase as more secondary propellant is added which was observed from an augmentation ratio of zero up to about 0.9. However, after that it decreases with added propellant. Without being bound to any theory, this may indicate that injecting more peroxide beyond this point has a chilling effect to the flow. Up to that point the heat released from the decomposition and combustion of the peroxide is able to drive the liquid evaporation and increase the thrust. However, once this maximum is passed, the liquid evaporation process becomes dominant and absorbs the needed enthalpy to drive decomposition.

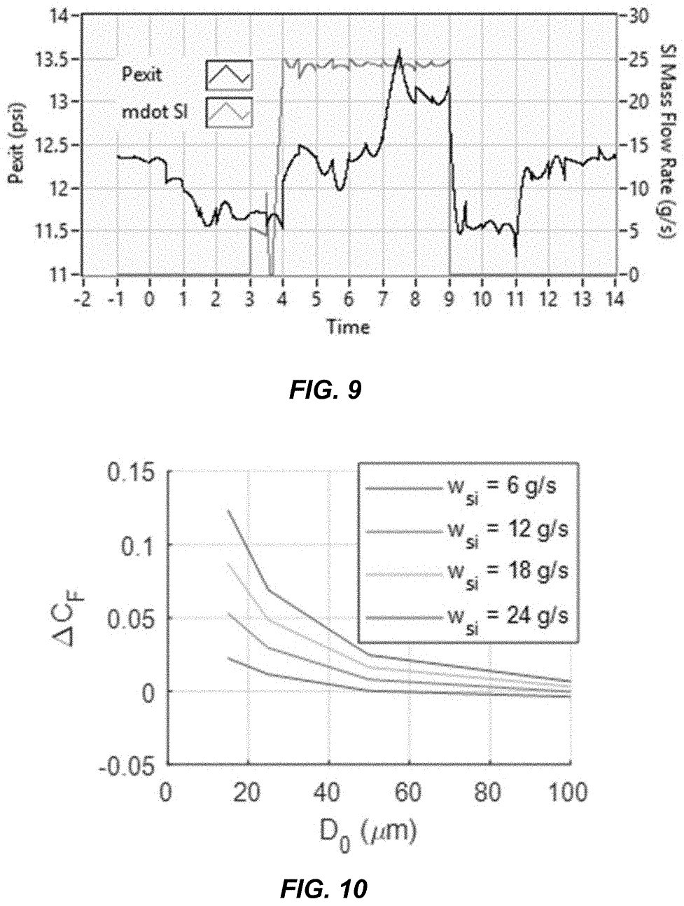

FIG. 9 is a graph of exit pressure and secondary injection mass flow rate as a function of time for Test 10. A clear correlation in increased pressure with secondary injection can be seen. It was also observed that generally an decrease in droplet sizes (from the injection nozzle) resulted in increased thrust coefficients and increase in decomposition percentage of the secondary propellant as partially shown in FIG. 10.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A rocket motor, comprising:
a combustion chamber containing a solid fuel that is operable to burn during operation of the rocket motor to generate combustion gas and unburned gaseous fuel;
a propellant supply containing an energy-rich oxidizer with a decomposition energy greater than or equal to 1 MJ/kg; and
a thrust augmented nozzle (TAN) operably coupled to the combustion chamber to receive the combustion gas from the combustion chamber and direct a flow of the combustion gas through the TAN, the TAN having a divergent portion downstream of a throat, and a propellant injection port associated with the divergent portion and in communication with the propellant supply to inject the energy-rich oxidizer into the divergent portion,
wherein only the energy-rich oxidizer, independent of another propellant, is introduced into the flow of the combustion gas and the unburned gaseous fuel for secondary combustion of the unburned gaseous fuel and thermal decomposition of the energy-rich oxidizer within the divergent portion.

2. The rocket motor of claim 1, wherein the energy-rich oxidizer comprises at least one of hydrogen peroxide or nitrous oxide.

3. The rocket motor of claim 2, wherein the energy-rich oxidizer comprises a hydrogen peroxide solution having a concentration greater than or equal to 85%.

4. The rocket motor of claim 3, wherein the hydrogen peroxide solution has a concentration of 90%.

5. The rocket motor of claim 1, wherein the injected energy-rich oxidizer has a droplet size less than or equal to 50 microns.

6. The rocket motor of claim 1, wherein the propellant injection port comprises at least one of an atomizer or a conical spray head.

7. The rocket motor of claim 1, wherein the propellant injection port is oriented at a forward-facing injection angle.

8. The rocket motor of claim 7, wherein the propellant injection port is oriented at a forward-facing injection angle up to and including 10 degrees.

9. The rocket motor of claim 1, wherein the TAN has an expansion ratio nozzle greater than or equal to 10:1-50:1.

10. The rocket motor of claim 1, wherein the rocket motor is selectively operable with and without secondary combustion.

11. The rocket motor of claim 1, wherein the TAN is configured to operate in an over-expanded condition at sea-level without secondary combustion.

12. The rocket motor of claim 1, further comprising a first oxidizer injection port associated with the combustion chamber and operable to inject a first oxidizer into the combustion chamber to facilitate combustion of the solid fuel.

13. The rocket motor of claim 12, wherein the oxidizer comprises at least one of hydrogen peroxide, gaseous oxygen, liquid oxygen, nitrous oxide, hydroxylammonium nitrate, ammonium dinitramide, or air.

14. The rocket motor of claim 12, further comprising a second oxidizer injection port associated with the combustion chamber and operable to inject a second oxidizer into the combustion chamber to initiate combustion between the second oxidizer and the solid fuel prior to injection of the first oxidizer to facilitate thermal decomposition of the first oxidizer.

15. The rocket motor of claim 14, wherein the second oxidizer comprises gaseous oxygen.

16. The rocket motor of claim 1, wherein the solid fuel comprises a thermoplastic material.

17. The rocket motor of claim 16, wherein the thermoplastic material comprises at least one of acrylonitrile butadiene styrene (ABS), low density polyethylene (LDPE), or high-impact polystyrene (HIPS).

18. The rocket motor of claim 1, wherein the solid fuel comprises at least one of a cylindrical fuel grain, a helical bore fuel grain, or an ignition system.

19. A method for augmenting thrust of a rocket motor, comprising:
burning a solid fuel to generate combustion gas and unburned gaseous fuel;
directing flow of the combustion gas and the unburned gaseous fuel through a divergent portion of a nozzle; and
introducing an energy-rich oxidizer with a decomposition energy greater than or equal to 1.0 MJ/kg into the divergent portion,
wherein only the energy-rich oxidizer, independent of another propellant, is introduced into the flow of the combustion gas and the unburned gaseous fuel for secondary combustion of the unburned gaseous fuel and thermal decomposition of the energy-rich oxidizer within the divergent portion.

20. The method of claim 19, wherein the energy-rich oxidizer comprises at least one of hydrogen peroxide or nitrous oxide.

21. The method of claim 19, wherein introducing the energy-rich oxidizer comprises forming the energy-rich oxidizer into droplets sized less than or equal to 50 microns.

22. The method of claim 19, wherein introducing the energy-rich oxidizer comprises directing the energy-rich oxidizer at a forward-facing injection angle.

23. The method of claim 19, further comprising introducing a fluid oxidizer to the solid fuel while burning the solid fuel.
